(19) United States
(12) Patent Application Publication
(10) Pub. No.: US 2025/0245814 A1
(43) Pub. Date: Jul. 31, 2025

(54) INSPECTION APPARATUS AND OPERATION METHOD OF THE SAME

(71) Applicant: BRIGHTEST TECHNOLOGY TAIWAN CO., LTD., HSINCHU COUNTY (TW)

(72) Inventors: Zhonghua DONG, SUNNYVALE, CA (US); ChengWei HSU, HSINCHU COUNTY (TW)

(21) Appl. No.: 18/425,049

(22) Filed: Jan. 29, 2024

(51) Int. Cl. G06T 7/00; G01N 21/95; G01N 23/2204; G01N 23/2251; G06T 7/30; G06T 7/70

(52) U.S. Cl. CPC G06T 7/001; G01N 21/9501; G01N 23/2204; G01N 23/2251; G06T 7/30; G06T 7/70; G01N 2223/303; G01N 2223/6116; G01N 2223/646; G06T 2207/10061; G06T 2207/30148

(57) ABSTRACT

A inspection apparatus includes a sample stage, an optical imaging system, and a scanning electron microscope (SEM) system. The sample stage is configured to bear a sample. The optical imaging system is configured to obtain a first image from the sample stage. The SEM system is configured to obtain a second image from the sample stage. The inspection apparatus is placed in a vacuum chamber.

### BACKGROUND

### Field of Invention

The present invention relates to an inspection apparatus and an operation method. More particularly, the present invention relates to an inspection apparatus and corresponding operation method.

### Description of Related Art

Position accuracy is crucial in high resolution inspection of advanced nodes. Due to resolution limitation, optical based sample coordinate alignment, coordinate calibration, and wafer inspection cannot provide high precision and reliable results. For small defect inspection, optical imaging system modification time becomes longer due to the poor optical image quality and it's difficult to get a good optical condition. On the contrary, SEM inspection can provide high quality image, reliable position alignment and calibration results. However, defects inspection merely by a SEM system is time-consuming.

Accordingly, it is still a development direction for the industry to provide an inspection apparatus and operation method having high precision and efficiency.

### SUMMARY

The invention provides an inspection apparatus.

In some embodiments, the inspection apparatus includes a sample stage, an optical imaging system, and a scanning electron microscope (SEM) system. The sample stage is configured to place a sample. The optical imaging system is configured to obtain a first image from the sample stage. The SEM system is configured to obtain a second image from the sample stage. The inspection apparatus is placed in a vacuum chamber.

In some embodiments, the optical imaging system includes a light source, an illuminator, an imaging optical, and an image sensor. The light source is configured to emit a light beam.

In some embodiments, a wavelength of the light beam is substantially smaller than 120 nm.

In some embodiments, the SEM system includes an electron source, a column, a high voltage system, scan driver, a lens driver, and an image channel system.

In some embodiments, the inspection apparatus further includes a stage position measurement unit configured to obtain a position information of the sample stage.

In some embodiments, a resolution of the first image is different from a resolution of the second image.

In some embodiments, the resolution of the second image is higher than the resolution of the first image.

In some embodiments, a sample alignment is performed by obtaining at least one of the first image and the second image.

In some embodiments, a defect inspection is performed by obtaining the first image, and determining a region of interest on the first image.

In some embodiments, the defect inspection further includes obtaining the second image according to the region of interest on the first image.

The invention provides an operation method of an inspection apparatus.

In some embodiments, the operation method includes executing sample alignment by obtaining a sample image of a sample placed on a sample stage from at least one of an optical imaging system and a SEM system; executing defect inspection, and modifying an optical condition of the optical imaging system by comparing an optical image from the optical imaging system and a SEM image from the SEM system. Executing defect inspection includes obtaining a first image from the optical imaging system; determining a region of interest on the first image; obtaining a second image according to the region of interest on the first image by the SEM system; and monitoring the defect inspection by redetecting the second image by the SEM system.

In some embodiments, executing defect inspection further includes outputting defect locations of the first image, and monitoring the defect inspection by redetecting the second image further includes redetecting the second image to get a defect false rate when defect locations are detected.

In some embodiments, modifying the optical condition of the optical imaging system further includes adjusting the optical condition of the optical imaging system; determining whether an optical image quality conforms with requirements; comparing an optical defect signal to noise ratio (SNR) of the optical image with a SEM defect SNR of the SEM image; and determining whether the optical defect SNR is higher than a threshold.

In some embodiments, when the optical image quality does not conforms with requirements, the step of adjusting the optical condition of the optical imaging system further includes repeating acquiring optical image; and comparing the optical images with the SEM image to select a preferred optical image.

In some embodiments, when the optical defect SNR is not higher than the threshold, the step of modifying the optical condition of the optical imaging system further includes repeating the step of adjusting the optical condition of the optical imaging system; repeating acquiring optical image; and repeating comparing the optical defect SNR of the optical image with the SEM defect SNR of the SEM image to select a preferred optical defect SNR.

In some embodiments, the operation method further includes eliminating a linear coordinate error between a sample coordinate system and a stage coordinate system by obtaining the second image from the SEM system for a linear coordinate calibration.

In some embodiments, the linear coordinate calibration is performed during the step of executing the defect inspection.

In some embodiments, the operation method further includes eliminating a non-linear coordinate error between a sample coordinate system and a stage coordinate system by obtaining the second image from the SEM system for a non-linear coordinate calibration.

In some embodiments, the non-linear coordinate calibration includes selecting a plurality of target patterns of a sample; determining a plurality of first positions of the plurality of target patterns in the stage coordinate system by converting a plurality of second positions of the plurality of target patterns in the sample coordinate system; obtaining the SEM image of the plurality of the target patterns by moving the sample stage; comparing a plurality of third positions of the plurality of the target patterns in the SEM image with the first positions in the stage coordinate system; and eliminating the non-linear coordinate error.

In some embodiments, the non-linear coordinate calibration is performed during the step of executing the defect inspection.

In some embodiments, the non-linear coordinate calibration includes generate a mapping table between the third positions of the plurality of the target patterns in the SEM image and the first positions in the stage coordinate system; and eliminating the non-linear coordinate error by means of the mapping table before the step of sample alignment.

### BRIEF DESCRIPTION OF THE DRAWINGS

The invention can be more fully understood by reading the following detailed description of the embodiment, with reference made to the accompanying drawings as follows:

FIG. 1 is a schematic of an inspection apparatus according to an embodiment of the present disclosure.

FIG. 2 is a schematic of the SEM system in FIG. 1.

FIG. 3 is a schematic of electrical potential of an electron beam from the electron source to the wafer according to an embodiment of the present disclosure.

FIG. 4 is a flow chart of an operation method of the inspection apparatus according to an embodiment of the present disclosure.

FIG. 5 is a flow chart of the linear coordinate calibration and the non-linear coordinate calibration according to an embodiment of the present disclosure.

FIG. 6 is a flow chart of a method of the non-linear coordinate calibration according to an embodiment of the present disclosure.

FIG. 7 is a schematic of the non-linear coordinate calibration according to an embodiment of the present disclosure.

FIG. 8 and FIG. 9 are flow charts of a method of modifying an optical condition of the optical imaging system by comparing the optical image from the optical imaging system and the SEM image from the SEM system according to an embodiment of the present disclosure.

FIG. 10 and FIG. 11 are flow charts of a method of monitoring a defect inspection process of the optical imaging system by a SEM system according to an embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

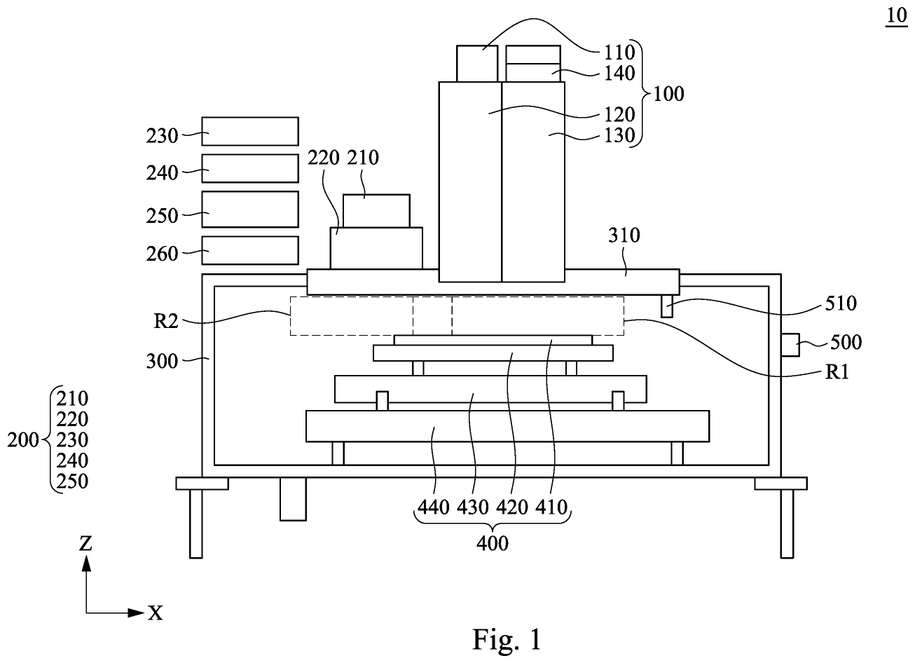

FIG. 1 is a schematic of an inspection apparatus 10 according to an embodiment of the present disclosure. The inspection apparatus 10 includes an optical imaging system 100, a SEM system 200. The optical imaging system 100 and the scanning electron microscope (SEM) system 200 are integrated with a vacuum chamber 300.

The optical imaging system 100 includes a light source 110, an illuminator 120, an imaging optical 130, and an image sensor 140. The light source 110 is configured to emit a first light beam L1. The optical imaging system 100 is a short wavelength optical imaging system that is operated under a vacuum or low air pressure environment. For example, a wavelength of the first light beam L1 is substantially smaller than 120 nm, and the air pressure is under 10e−5 Pa. The image sensor 140 could be a time delay integration (TDI) image sensor. The image sensor 140 receives a second light beam L2 reflected or scattered by a sample inspected to generate an optical image.

The SEM system 200 includes an electron source 210 for generating an electron beam, a column 220, high voltage system 230, a scan driver 240, a lens driver 250, and an image channel system 260. The high voltage system 230 is configured to supply voltage for the electron source 210 and the column 220. The scan driver 240 and lens driver 250 are configured to control a path of the electron beam. The image channel system 260 is configured to collect secondary electron signal and back scatter electron signal, and the signals are converted to SEM images.

The inspection apparatus 10 further includes a sample stage 400 in the vacuum chamber 300. The sample stage 400 is located under the optical imaging system 100 and the SEM system 200. The sample stage 400 is configured to bear and move a sample 410 to certain positions for inspection and image acquisition. The sample stage 400 includes an electrostatic chuck 420 for holding the sample 410, a vertical mechanism 430 for moving the sample 410 in a vertical direction (e.g., z direction), and a horizontal mechanism 440 for moving the sample 410 in horizontal directions (e.g., x direction and y direction). The sample 410 could be various semiconductor substrates such as wafer, pellicle, mask, and etc.

The inspection apparatus 10 further includes a stage position measurement system 500 such as an interferometer or an optical ruler. The stage position measurement system 500 includes a mirror 510 presented inside the vacuum chamber 300. The stage position measurement system 500 is configured to provide position of the sample stage 400 relative to the optical imaging system 100 and SEM system 200.

The SEM system 200 is required to be operated under vacuum. Therefore, the optical imaging system 100 and the SEM system 200 require similar environment requirement conditions. As shown in FIG. 1, the vacuum chamber 300 includes a top chamber 310 which has an opening. The optical imaging system 100 and the SEM system 200 are installed on the top chamber 310 through the opening above the sample stage 400.

The optical imaging system 100 has a first inspection region R1, and the SEM system 200 has a second inspection region R2. The first inspection region R1 may overlap with the second inspection region R2. The first inspection region R1 may partially overlap with the second inspection region R2. In other words, the optical imaging system 100 and the SEM system 200 can inspect the same sample 410 under the same stage coordinate system. The space in the vacuum chamber 300 communicates with the first inspection region R1 and the second inspection region R2. As such, the sample 410 does not need to be transferred between different stages or chambers. Accordingly, there is no alignment error caused by switching the sample 410 between an optical inspection process and a SEM inspection process.

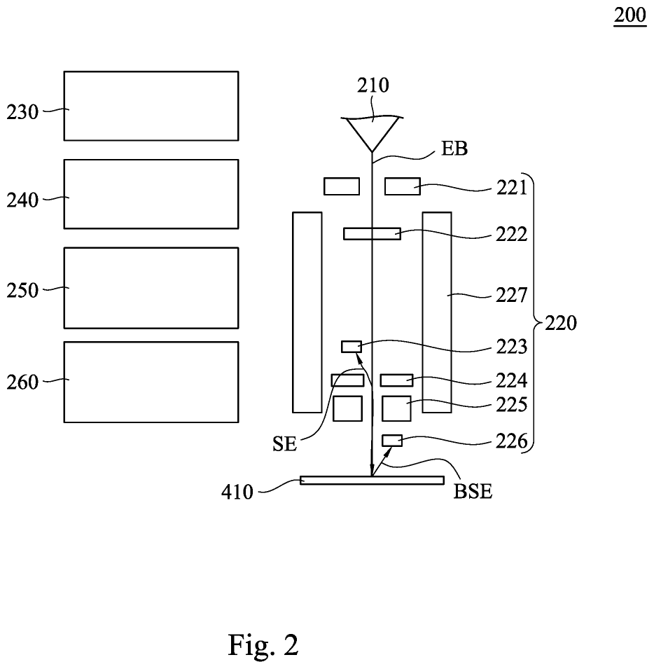

FIG. 2 is a schematic of the SEM system 200 in FIG. 1. The column 220 of the SEM system 200 includes condense lenses 221, an aperture 222, a secondary electron detector 223, a deflector 224, objective lenses 225, back secondary electron detector 226, and column booster 227. The scan driver 240 is configured to control the deflector 224, to adjust the path of the electron beam. The lens driver 250 is configured to control the condense lenses 221 and objective lenses 225 to condense an electron beam EB emitted from the electron source 210. The high voltage system 230 is configured to control the electron source 210 and column booster 227. Beam current of the electron beam EB is adjusted by passing through the aperture 222. Trajectory of the electron beam EB onto the sample 410 is controlled by the deflector 224. The column booster 227 accelerates the electron beam EB by means of the electrode therein (not shown). The secondary electron detector 223 is configured to detect secondary electron beam SE. The back secondary electron detector 226 is configured to detect back scatter electron BSE. The image channel system 260 is configured to amplify and condition secondary electron SE signal and back scatter electron BSE signal from the secondary electron detector 223 and the back secondary electron detector 226 and convert to SEM images.

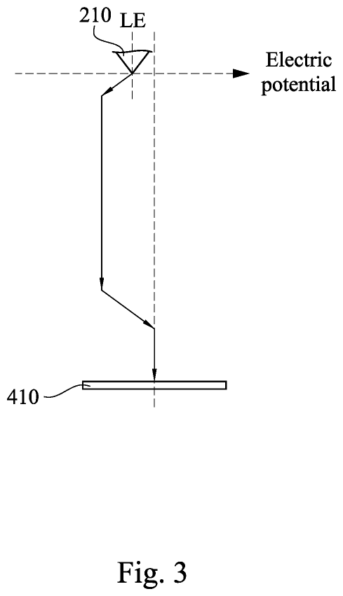

FIG. 3 is a schematic of electrical potential of an electron beam EB from the electron source 210 to the sample 410 according to an embodiment of the present disclosure. The electric potential difference between the sample 410 and the electron source 210 is the landing energy LE. For example, the typical landing energy of the present embodiment is in a range from 500 eV to 12 keV. The sample 410 has a ground potential. When the landing energy is lower than 2 keV, the column 220 may provide accelerating voltage such as −8 kV. In such condition, resolution of the SEM system 200 can be better than 3 nm at 1 keV landing energy. For example, resolution of the optical imaging system 100 is about 60 nm. By using the SEM inspection process and the optical inspection process both can optimize the inspection parameters of the optical imaging system 100. Hence, the optical imaging system 100 may adaptable for various defect types.

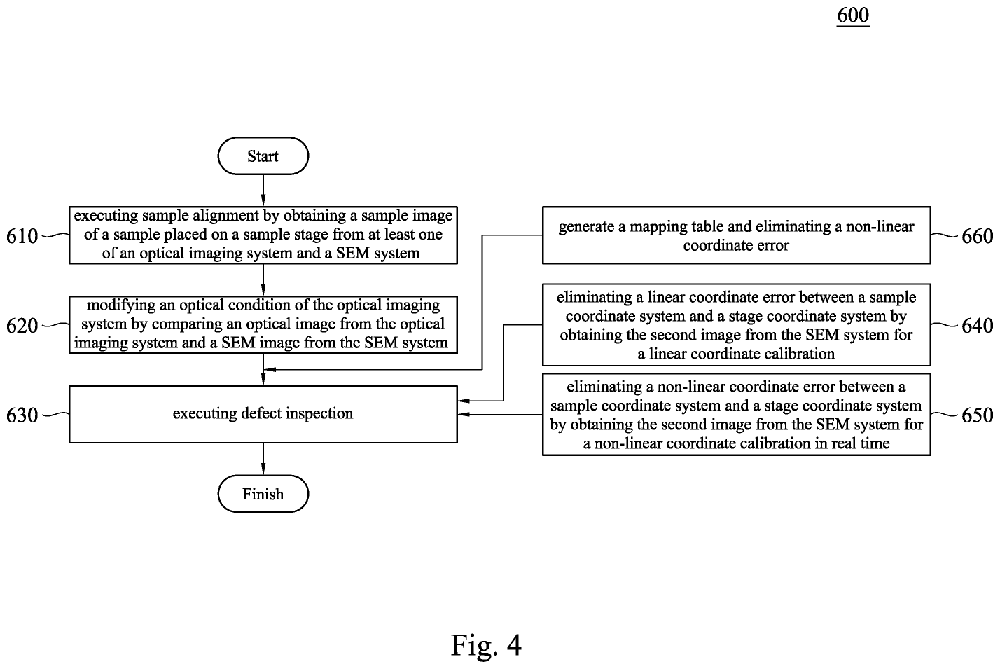

Reference is made to FIG. 4. FIG. 4 is a flow chart of an operation method 600 of the inspection apparatus 10 according to an embodiment of the present disclosure. The operation method 600 begins with step 610, a sample alignment is executed by obtaining a sample image of a sample 410 placed on the sample stage 400 from at least one of an optical imaging system 100 and a SEM system 200. The operation method 600 continuous to step 620, modify an optical condition of the optical imaging system 100 by comparing an optical image from the optical imaging system 100 and a SEM image from the SEM system 200.

The operation method 600 continuous to step 630, a defect inspection is executed. In step 630, a first image is obtained from the optical system first, and then a region of interest (ROI) on the first image is determined. Subsequently, a second image is obtained by the SEM system according to the region of interest on the first image. Finally, monitoring the defect inspection by redetecting the second image by the SEM image.

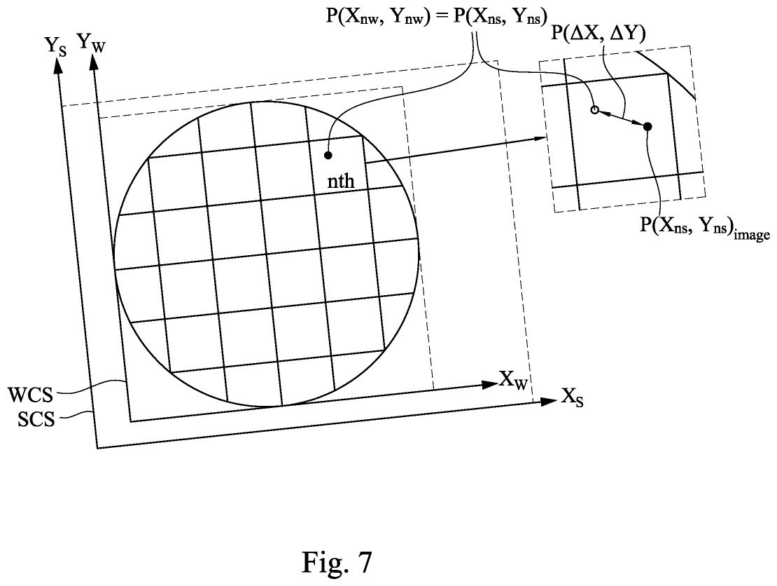

During the defect inspection in step 630, step 640 can be performed once or multiple times. In step 640, eliminating a linear coordinate error between a sample coordinate system and a stage coordinate system by obtaining the second image from the SEM system 200 for a linear coordinate calibration. During the defect inspection in step 630, step 650 can be performed once or multiple times. In step 650, eliminating a non-linear coordinate error between a sample coordinate system and a stage coordinate system by obtaining the second image from the SEM system 200 for a non-linear coordinate calibration in real time. The non-linear calibration is performed to eliminate a non-linear coordinate error between a plurality of pattern positions in a sample coordinate system and a stage coordinate system. Step 640 and step 650 will be described in detail in the following paragraphs. Step 660 is similar to step 650 and is performed to eliminate non-linear coordinate error before executing defect inspection (step 630). The difference between step 650 and step 660 will be described in FIG. 7.

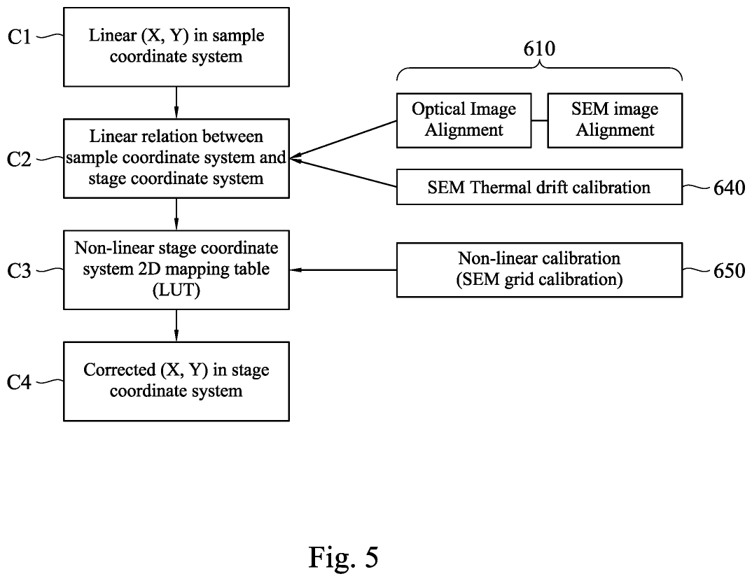

Reference is made to FIG. 4 and FIG. 5. FIG. 5 is a flow chart of the linear coordinate calibration and the non-linear coordinate calibration according to an embodiment of the present disclosure. During the operation method 600 of the inspection apparatus 10, patters (e.g., active elements) on the sample 410 have coordinates indicated in a sample coordinate system (C1). In an ideal condition, the sample coordinate system can linearly correlate with a stage coordinate system. After loading the sample 410, step 610 (see FIG. 4) is performed. For example, sample alignment may be firstly performed by the optical imaging system 100, then performed by SEM system 200. A high-resolution image of the SEM system 200 can be used to provide more accurate and reliable alignment results compare with optical imaging system 100. In some embodiments, if the pixel size of the wafer alignment process is 5 nm, the maximum linear error among the whole sample 410 can be reduced to less than 20 nm.

In addition, step 640 is performed during the defect inspection (step 630 in FIG. 4) to further eliminate linear coordinate error between the sample coordinate system and the stage coordinate system. For example, scale error, offset, or orthogonality error caused by thermal drift of the sample stage 400 and stage position measurement system 500 may occur during inspection process. Therefore, a high-resolution SEM image can be used to eliminate those linear coordinate errors in real-time. In other words, since the SEM system 200 and the optical imaging system 100 are integrated with the same vacuum chamber 300 and the same sample stage 400, step 630 can be performed at any time during the inspection process (step 630). As such, the linear relation between the sample coordinate system and the stage coordinate system (C2) without linear coordinate error is determined.

Step 650 is performed to eliminate non-linear coordinate error between the sample coordinate system and the stage coordinate system. The non-linear coordinate error is caused by planar errors (straightness and flatness) of the mirrors for stage position measurement system 500 and Abbe errors (such as angular errors-pitch error, yaw error, and roll error, which are caused by stage flatness and straightness). High-resolution SEM images are used to eliminate non-linear coordinate error which may be different among different regions of the sample 410. Specifically, the sample 410 is divided as a grid such that the non-linear coordinate error of each block of the grid obtained from high-resolution SEM images can be eliminated respectively. In other words, step 650 is a SEM grid calibration. Similarly, step 650 can be performed in real-time during the defect inspection process (step 630).

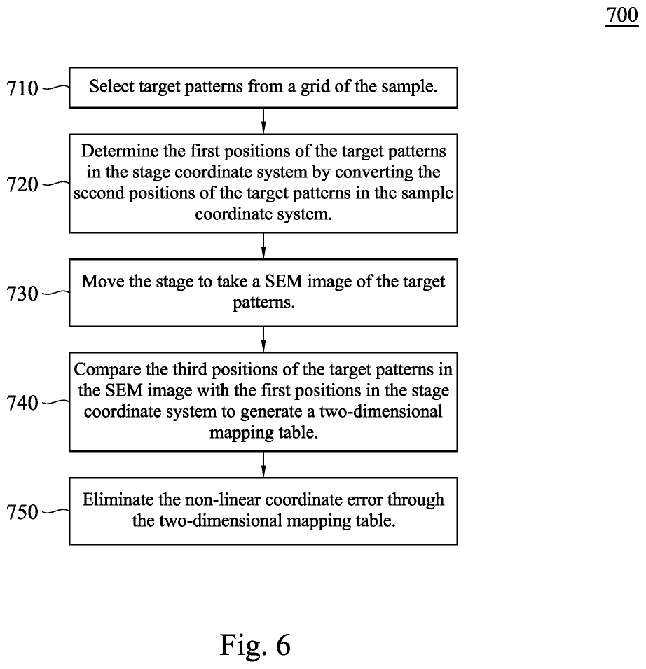

FIG. 6 is a flow chart of a method 700 of the non-linear coordinate calibration (step 650 and step 660 in FIG. 5) according to an embodiment of the present disclosure. FIG. 7 is a schematic of the non-linear coordinate calibration according to an embodiment of the present disclosure. As shown in FIG. 7, sample (wafer) coordinate system WCS typically has an angle with the stage coordinate system SCS. Reference is made to FIG. 6 and FIG. 7. In step 710, target patterns of the sample 410 are selected. The target patterns can be selected patterns in each block of the grid of the sample 410. The positions (second positions) of those target patterns in the sample (wafer) coordinate system WCS are known. As an example, coordinate (X_{nw}, Y_{nw}) of one of the target pattern P of the nth block of the grid is annotated in FIG. 7.

In step 720, the positions (first positions) of the target patterns in the stage coordinate system SCS can be determined by converting the second positions of the target patterns in the sample coordinate system WCS by means of the linear relation as described above (C2 in FIG. 5). As shown in FIG. 7, (Xₙₛ, Yₙₛ) of the target pattern P of the nth block of the grid is converted from the (X_{nw}, Y_{nw}).

In step 730, the sample stage 400 is moved to the first positions and SEM images of those target patterns are acquired. As such, the coordinate (third positions) of those target patterns can be shown in the SEM images. As shown in FIG. 7, (Xₙₛ, Yₙₛ)_{image} of the target pattern P in the nth block is obtained in the SEM image.

In step 740, compare the third positions with the first positions in the stage coordinate system SCS. As a result, position shifts of those target patterns are collected to generate a two-dimensional mapping table (i.e., Look Up Table, LUT in C3 in FIG. 5). As shown in FIG. 7, a shift (ΔX, ΔY) of the target pattern P of the nth block is determined by comparing (Xₙₛ, Yₙₛ)_{image} and (Xₙₛ, Yₙₛ). Based on the steps 710˜740, shifts of the target patterns of all the blocks of the grid can represent the non-linear coordinate error. Non-linear coordinate error of any positions of the sample 410 can be obtained by means of 2D interpolation.

In step 750, non-linear coordinate error of the stage coordinate system SCS are eliminated according to the two-dimensional mapping table. Therefore, a corrected coordinate in the stage coordinate system (C4 in FIG. 5) can be obtained. The step 660 in FIG. 4 includes steps 710˜750. The step 650 in FIG. 4 includes steps 710˜730 and 750, which is executed on the sample 410 partially based on the defects that need to be redetected.

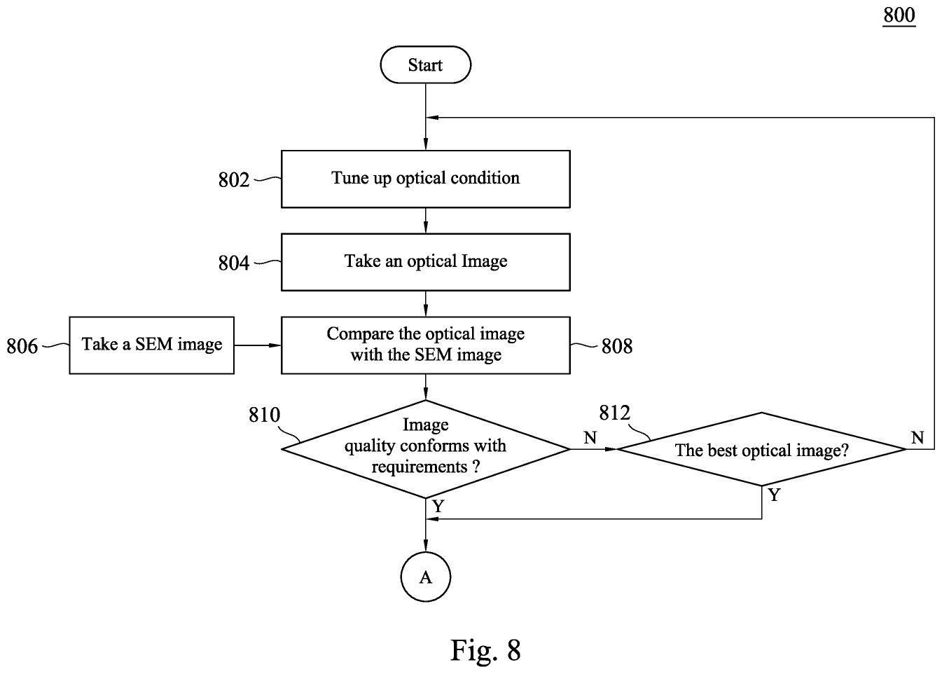

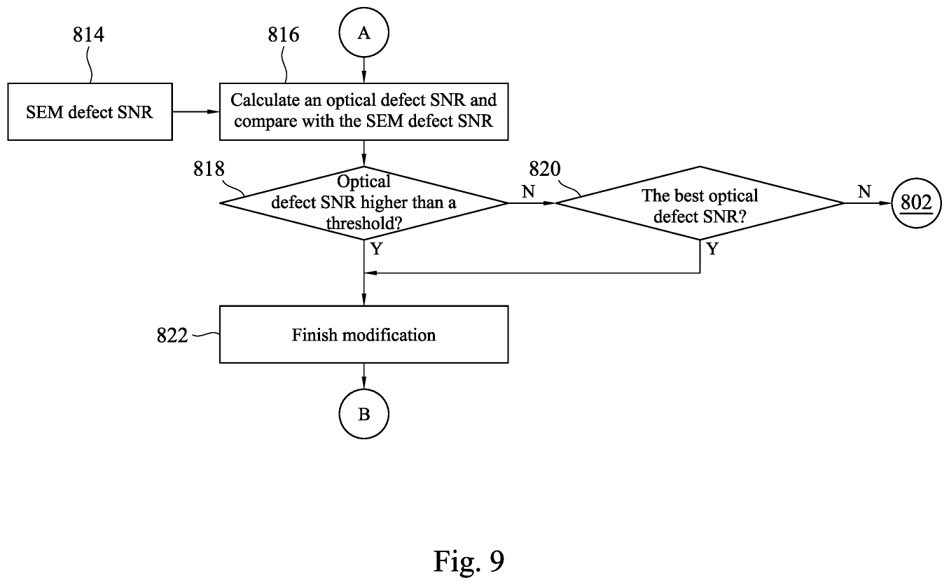

FIG. 8 and FIG. 9 are flow charts of a method 800 of modifying an optical condition of the optical imaging system by comparing the optical image from the optical imaging system and the SEM image from the SEM system (step 620 in FIG. 4) according to an embodiment of the present disclosure. Reference is made to FIG. 1 and FIG. 8. The method 800 begins with step 802, modify optical condition of the optical imaging system 100. In some embodiments, optical condition includes wavelength, light intensity, light incident angel, polarization state, focus, etc. In step 804, take an optical image of a certain pattern of the sample 410 based on the optical condition set in step 804. In step 806, take a SEM image of the same pattern said in step 804. In some embodiments, step 806 and step 804 can be exchanged.

The method 800 continues to step 808, compare the optical image and the SEM image of the same pattern. Specifically, since the SEM image has higher resolution, the SEM image is utilized as a reference. Therefore, an area of the sample is chosen to do the optical inspection process, and then to do the SEM inspection process. A false rate is acquired by the SEM inspection process and the optical inspection process. According to the result of the SEM inspection process to adjust to parameters of the optical condition in order to improve the quality of the optical inspection process.

Since the optical imaging system 100 and the SEM system 200 are integrated with the same vacuum chamber 300 and the same sample stage 400, step 808 can be done without transferring the sample 410 or changing the stage coordinate system. As such, it is beneficial for reducing mismatch between the positions of patterns determined by the optical imaging system 100 and the SEM system 200.

In step 810, determine whether the optical image quality conforms with requirements. If the image quality of the optical image does not conform with requirements, the method 800 continuous to step 812 and repeats a loop formed by step 802, step 804, step 808, and step 810. In each loop, a new optical image based on modified optical condition is taken and compared with the SEM image. In step 812, the optical images taken in step 804 repeatedly are compared to select a best one. After a best optical image is selected, the optical condition corresponding to the selected optical image is used in the following steps. If the image quality of the optical image conforms with requirements, the method 800 directly continuous to step 814 and step 816 in FIG. 9.

Reference is made to FIG. 1 and FIG. 9. In step 814, a SEM defect signal to noise ratio (SNR) is calculated from the SEM image taken in step 806. In this step, a defect signal method is defined, and therefore certain defects shown in the SEM image are used as reference.

In step 816, an optical defect signal to noise ratio (SNR) is calculated based on the optical image and optical condition obtained in steps 802˜810. The optical defect SNR is compared with the SEM defect SNR.

In step 818, determine whether the optical defect SNR is higher than a threshold. The threshold herein is a criterion used to determine whether the optical defect SNR is good enough.

If the optical defect SNR is not good enough, the method 800 continuous to step 820 and repeats the loop formed by step 802, step 804, step 808, step 810, step 816, and step 818. In each loop, a new optical image based on retuned optical condition is taken and compared with the SEM image. Therefore, a new optical defect SNR is calculated and compared with the SEM defect SNR to select the optical image having a highest optical defect SNR. In each loop, step 812 can be optional based on the practical condition. After a best optical defect SNR is selected, the optical condition corresponding to the selected optical defect SNR is used in the following steps. The method 800 continues to step 822 to finish the modification process.

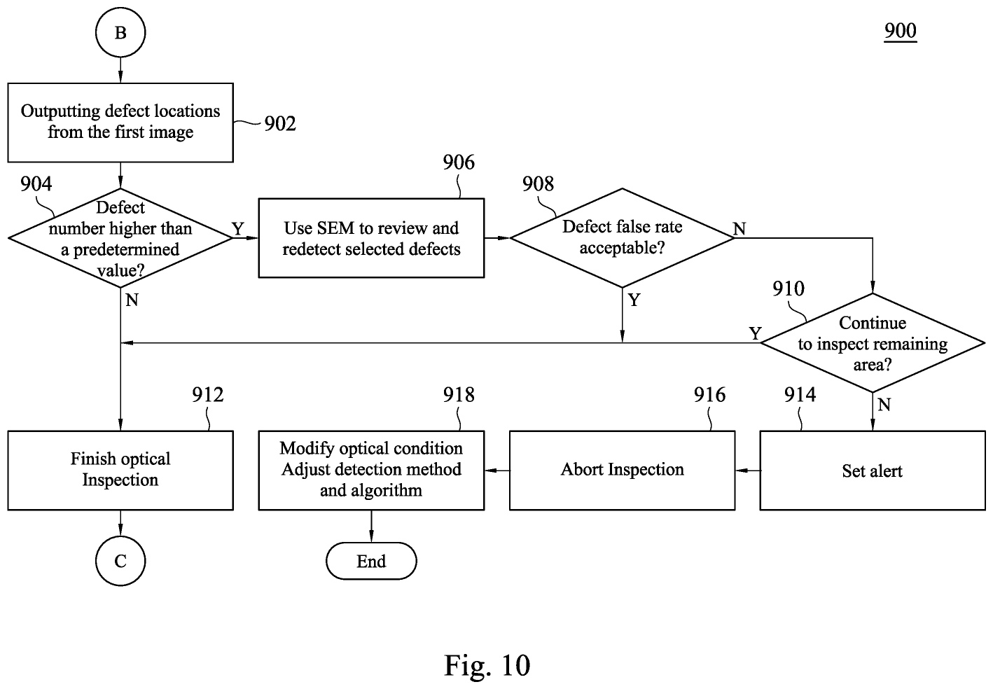

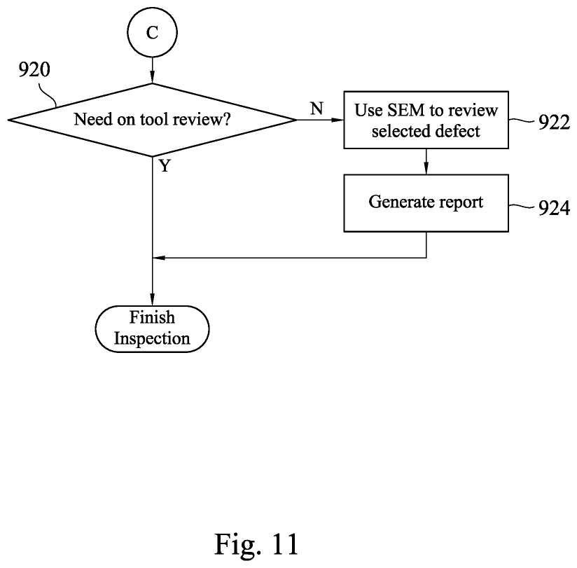

If the optical defect SNR is good enough in step 818, the method 800 directly continues to step 822 to finish the modification process. It indicated that the optical condition set in step 804 is the most proper condition for the following defect inspection process in FIG. 10 and FIG. 11.

According to those steps described above, the method 800 can significantly reduce the modification time of the optical imaging system 100 and increase the efficiency by using the SEM image as a reference.

FIG. 10 and FIG. 11 are flow charts of a method 900 of monitoring a defect inspection process of the optical imaging system by a SEM system (step 630 in FIG. 4) according to an embodiment of the present disclosure. Reference is made to FIG. 1 and FIG. 10. The method 900 begins with step 902, outputting defect locations from the first image obtained by the optical imaging system 100. Regions of interest (ROI) on the first image are determined.

Specifically, a defect number in the optical images is calculated. In step 904, determine whether the defect number is higher than a predetermined value. The predetermined value can be a common defect number based on previous inspection experiences. When the defect number of the defects selected in 904 is not higher than the predetermined value, the method continuous to step 906 to finish optical inspection.

When the defect number of the defects selected in 904 is higher than the predetermined value, the method continuous to step 906. In step 906, pause the optical inspection process and use SEM system 200 to review and redetect selected defects. Second images obtained by the SEM system according to the regions of interest on the first image are acquired. Since the resolution of the optical imaging system 100 is lower, the defect selected may not be the real defects. Therefore, the real defects can be confirmed through the high-resolution SEM images. As a result, a defect false rate of the defect number can be calculated in step 906.

In addition, since the optical imaging system 100 and the SEM system 200 are integrated with the same vacuum chamber 300 and the same sample stage 400, step 906 can be done without transferring the sample 410 or changing the stage coordinate system. As such, it is beneficial for reducing mismatch between the positions of defects determined by the optical imaging system 100 and the SEM system 200.

In step 908, determine whether the defect false rate is acceptable. The defect false rate is the ratio of false defect number detected by SEM system 200 with the number of defects selected by the optical imaging system 100.

If the false rate is acceptable, the method 900 continuous to step 912 to finish the optical inspection process. If the false rate is unacceptable, the method 900 continuous to step 910, decide to continue inspecting remaining area or not. If the result is not, the method 900 continues to set alert (step 914) and to abort inspection process (step 916). Lastly, the method 900 continuous to step 918 to modify optical condition again, adjust detection method and algorithm. If the result is yes in step 910, the remaining area is inspected and then the optical inspection process is finished.

Reference is made to FIG. 1 and FIG. 11. After step 912, the method 900 continues to step 920 to decide whether an on-tool review by the SEM system 200 is needed. If the result is yes, the defects selected by the optical imaging system 100 can be further reviewed by the SEM system 200 in step 922 and a report is generated in step 924. If the result is not in step 920, finish the inspection process.

It is noted that the linear coordinate calibration and the non-linear coordinate calibration discussed in FIGS. 4-7 can be performed between any steps of method 800 in real-time to eliminate coordinate error.

Based on the steps described above, the method 900 can provide review and redetect function in real-time during an optical inspection process. Therefore, the method 900 can significantly reduce the false rate and increase inspection efficiency.

In summary, the present disclosure provides a inspection apparatus and an operation method. The inspection apparatus has an optical imaging system and a SEM system that are integrated with the same chamber and the same sample stage. Therefore, operation between the optical imaging system and the SEM system can be done without transferring the wafer or changing the stage coordinate system. As such, it is beneficial for reducing mismatch between the positions of patterns or defects determined by the optical imaging system and the SEM system. A high-resolution SEM image can be used to eliminate image alignment error of the optical imaging system, linear coordinate errors, and non-linear coordinate errors in real-time. Modifying the optical condition by using a SEM image as a reference can significantly reduce the modification time of the optical imaging system and increase the efficiency. Monitoring a defect inspection process of the optical imaging system by using the review and redetect function of the SEM system in real-time can significantly reduce the false rate and increase inspection efficiency.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An inspection apparatus, comprising:
a sample stage, configured to place a sample;
an optical imaging system, configured to obtain a first image from the sample stage; and
a scanning electron microscope (SEM) system, configured to obtain a second image from the sample stage, wherein the inspection apparatus is placed in a vacuum chamber.

2. The inspection apparatus of claim 1, wherein the optical imaging system comprises a light source, an illuminator, an imaging optical, and an image sensor, wherein the light source is configured to emit a light beam.

3. The inspection apparatus of claim 2, wherein a wavelength of the light beam is substantially smaller than 120 nm.

4. The inspection apparatus of claim 1, wherein the SEM system comprises an electron source, a column, a high voltage system, scan driver, a lens driver, and an image channel system.

5. The inspection apparatus of claim 1, further comprising:
a stage position measurement unit configured to obtain a position information of the sample stage.

6. The inspection apparatus of claim 1, wherein a resolution of the first image is different from a resolution of the second image.

7. The inspection apparatus of claim 6, wherein the resolution of the second image is higher than the resolution of the first image.

8. The inspection apparatus of claim 1, wherein a sample alignment is performed by obtaining at least one of the first image and the second image.

9. The inspection apparatus of claim 1, wherein a defect inspection is performed by obtaining the first image, and determining a region of interest on the first image.

10. The inspection apparatus of claim 9, wherein the defect inspection further comprises:
obtaining the second image according to the region of interest on the first image.

11. An operation method of an inspection apparatus, comprising:
executing sample alignment by obtaining a sample image of a sample placed on a sample stage from at least one of an optical imaging system and a SEM system;
executing defect inspection, comprising:
obtaining a first image from the optical imaging system;
determining a region of interest on the first image;
obtaining a second image according to the region of interest on the first image by the SEM system; and
monitoring the defect inspection by redetecting the second image by the SEM system; and
modifying an optical condition of the optical imaging system by comparing an optical image from the optical imaging system and a SEM image from the SEM system.

12. The operation method of the inspection apparatus of claim 11, wherein executing defect inspection further comprises:
outputting defect locations of the first image; and
monitoring the defect inspection by redetecting the second image further comprises:
when defect locations are detected, redetecting the second image to get a defect false rate.

13. The operation method of the inspection apparatus of claim 11, wherein modifying the optical condition of the optical imaging system further comprises:
adjusting the optical condition of the optical imaging system;
determining whether an optical image quality conforms with requirements;
comparing an optical defect signal to noise ratio (SNR) of the optical image with a SEM defect SNR of the SEM image; and
determining whether the optical defect SNR is higher than a threshold.

14. The operation method of the inspection apparatus of claim 13, wherein when the optical image quality does not conforms with requirements, the step of adjusting the optical condition of the optical imaging system further comprises:
repeating acquiring optical image; and
comparing the optical images with the SEM image to select a preferred optical image.

15. The operation method of the inspection apparatus of claim 13, wherein when the optical defect SNR is not higher than the threshold, the step of modifying the optical condition of the optical imaging system further comprises:
repeating the step of adjusting the optical condition of the optical imaging system;
repeating acquiring optical image; and
repeating comparing the optical defect SNR of the optical image with the SEM defect SNR of the SEM image to select a preferred optical defect SNR.

16. The operation method of the inspection apparatus of claim 11, further comprising:
eliminating a linear coordinate error between a sample coordinate system and a stage coordinate system by obtaining the second image from the SEM system for a linear coordinate calibration.

17. The operation method of the inspection apparatus of claim 16, wherein the linear coordinate calibration is performed during the step of executing the defect inspection.

18. The operation method of the inspection apparatus of claim 11, further comprising:
eliminating a non-linear coordinate error between a sample coordinate system and a stage coordinate system by obtaining the second image from the SEM system for a non-linear coordinate calibration.

19. The operation method of the inspection apparatus of claim 18, wherein the non-linear coordinate calibration comprises:
selecting a plurality of target patterns of a sample;
determining a plurality of first positions of the plurality of target patterns in the stage coordinate system by converting a plurality of second positions of the plurality of target patterns in the sample coordinate system;
obtaining the SEM image of the plurality of the target patterns by moving the sample stage;
comparing a plurality of third positions of the plurality of the target patterns in the SEM image with the first positions in the stage coordinate system; and
eliminating the non-linear coordinate error.

20. The operation method of the inspection apparatus of claim 19, wherein the non-linear coordinate calibration is performed during the step of executing the defect inspection.

21. The operation method of the inspection apparatus of claim 19, wherein the non-linear coordinate calibration comprises:
generating a mapping table between the third positions of the plurality of the target patterns in the SEM image and the first positions in the stage coordinate system; and
eliminating the non-linear coordinate error by means of the mapping table before the step of sample alignment.
